(19) United States
(12) Patent Application Publication
(10) Pub. No.: US 2005/0116058 A1
(43) Pub. Date: Jun. 2, 2005

(54) Control of a pressure exchanger by displacement of an injection valve member

(76) Inventor: Hans-Christoph Magel, Pfullingen (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 10/504,965

(22) PCT Filed: Apr. 3, 2003
(86) PCT No.: PCT/DE03/01100

(30) Foreign Application Priority Data
Jun. 29, 2002 (DE) 102 29 413.5

(51) Int. Cl. F02M 47/02

(52) U.S. Cl. 239/88; 239/533.2

(57) ABSTRACT

A device for injecting fuel into a combustion chamber of an internal combustion engine, including an injector body which contains an injection valve element which can be actuated through pressurization/pressure relief of a control chamber by means of a control valve. A pressure booster having a piston unit that divides a working chamber from a control chamber of the pressure booster acts on a compression chamber that communicates with a nozzle chamber encompassing the injection valve element. A pressurization or pressure relief of the control chamber of the pressure booster occurs as a function of the stroke motion of the injection valve element.

### TECHNICAL FIELD

Both pressure-controlled and stroke-controlled injection systems can be used to supply fuel to combustion chambers of autoignition internal combustion engines. In addition to unit injectors and unit pumps, accumulator injection systems are also used as fuel injection systems. Accumulator (common rail) injection systems advantageously make it possible to adapt the injection pressure to the load and speed of the autoignition internal combustion engine. Achieving high specific outputs and reducing emissions of the autoignition engine generally require the highest possible injection pressure.

### PRIOR ART

For strength reasons, the achievable pressure level in accumulator injection systems currently in use is limited to approximately 1600 bar at this time. In order to further increase the pressure in accumulator injection systems, common rail systems employ pressure boosters.

DE 199 10 970 A1 relates to a fuel injection apparatus. This fuel injection apparatus has a pressure booster unit, which is disposed between a pressure accumulator and a nozzle chamber and whose pressure chamber is connected to the nozzle chamber via a pressure line. In addition, a bypass line is provided, which is connected to the pressure accumulator. The bypass line is connected directly to the pressure line. The bypass line can be used for a pressure injection and is disposed parallel to the pressure chamber so that the bypass line is continuously independent of the movement and position of a moving pressure fluid in the pressure booster unit. This feature increases the flexibility of the injection. A differential chamber can be connected to a leakage line via a 2/2-way valve and there is a connection from the differential chamber to the pressure accumulator. A valve device, which is disposed outside the injector at an arbitrary point between the pressure accumulator and the injector, is associated with the pressure booster unit in order to control it.

DE 190 40 526 A1 also relates to a fuel injection apparatus. This fuel injection apparatus has a pressure booster unit, which is disposed between a pressure accumulator and a nozzle chamber and has a moving piston unit for boosting the pressure of the fuel to be supplied to the nozzle chamber. In order to control the pressure booster unit, the piston unit has a transition from a larger piston cross-section to a smaller piston cross-section and a differential chamber formed as a result of this. The differential chamber is connected to the pressure accumulator by means of a filling path that contains a filling valve. This permits a reduction of the control quantity during the triggering of the pressure booster unit and permits a rapid resetting of the piston unit.

In view of ever-increasing standards regarding emissions and noise production in autoignition internal combustion engines, further steps must be taken in the injection system in order to meet the stricter limit values to be expected in the near future.

### DEPICTION OF THE INVENTION

With the design proposed according to the invention, it is possible to control a fuel injector of a fuel injection system with an actuator, which makes it possible to significantly reduce the complexity and costs of production. In particular, the design proposed according to the invention makes it possible to produce a pressure booster by making direct use of the movement of an injection valve element advantageously embodied as a nozzle needle, thus eliminating the need for a separate actuator. The pressure booster can be switched on with the opening movement of the injection valve element. The pressure booster contains a piston unit, which separates the working chamber of the pressure booster from its control chamber and can be set with a partial stroke, the passage of which permits the pressure booster to be switched on. This achieves considerable advantages with regard to the design of a fuel injector with a pressure booster. For example, it is possible to execute multiple preinjections into the combustion chamber of an autoignition internal combustion engine without activating the pressure booster. It is therefore possible to execute a preinjection, which occurs at a pressure level that essentially corresponds to the pressure level prevailing inside a high-pressure accumulator (common rail). After the piston unit of the pressure booster has traveled its set stroke distance, a main injection can be executed with an activated pressure booster, thus resulting in the production of a high pressure level during the main injection, which has a favorable effect on the emissions of autoignition internal combustion engines and is higher than the pressure prevailing inside a high-pressure accumulator (common rail). This makes it possible to achieve a boot-shaped injection since the first injection phase (preinjection phase) occurs at a lower pressure and then a pressure increase to the boosted injection pressure occurs. The activation of the pressure booster can produce a pressure increase up to the maximal permissible pressure during the main injection phase when the injection valve element is in the open position. Furthermore, the design proposed according to the invention makes it possible to achieve the pressure booster before the closing of the injection valve element that is preferably embodied as a nozzle needle, which makes it possible to prevent pressure surges above the maximal injection pressure when the needle closes. This has a favorable effect on the service life of the fuel injection system in an autoignition internal combustion engine. In addition, the design according to the invention can execute a secondary injection phase at a very high injection pressure after the main injection phase, as well as a stepped secondary injection that follows the main injection by a somewhat longer time span.

### DRAWINGS

The invention will be explained in detail below in conjunction with the drawings.

FIG. 1 shows an embodiment version of a pressure booster actuated by an injection valve element in a first state,

FIG. 2 shows the embodiment version of the design proposed according to the invention according to FIG. 1, with a pressure booster in a second state,

FIG. 3 shows another embodiment version of a pressure booster that can be actuated by an injection valve element, with two valve elements guided one inside the other, and

FIG. 4 shows an embodiment version of a pressure booster actuated by an injection valve element, with two valve elements, one of which is spring-loaded.

### EMBODIMENT VERSIONS

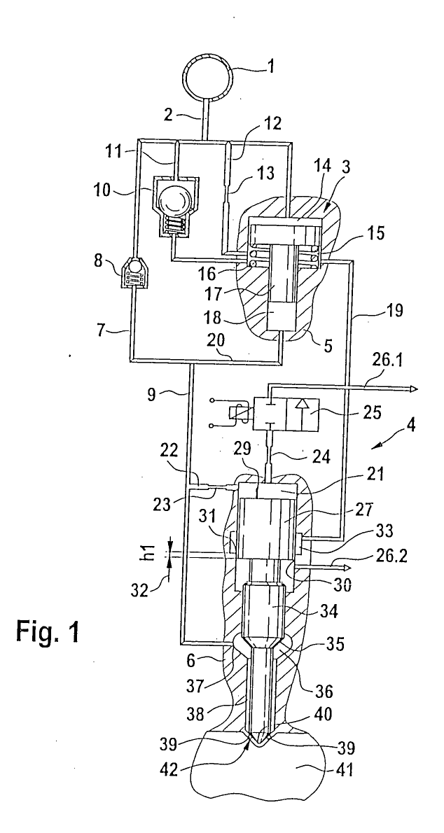

FIG. 1 shows a first embodiment version of a pressure booster that can be actuated by an injection valve element, depicted in a first state in which the control chamber of the pressure booster is disconnected from the return, i.e. from the low-pressure region of the fuel injection system.

Starting from a high-pressure source 1, which can be embodied, for example, as a high-pressure accumulator (common rail), a high-pressure inlet 2 extends to a pressure booster 3. The high-pressure inlet 2 has a high-pressure line 7 that can contain a check valve 8. Parallel to the high-pressure line 7, the high-pressure inlet 2 from the high-pressure source 1 acts on a parallel branch 11 that can contain a filling valve 10. Another branch 12 extends parallel to it, which contains a throttle restriction 13. The first parallel branch that contains the filling valve 10 and the additional parallel branch 12 that contains the throttle restriction 13 feed into a control chamber 15 of the pressure booster 3. The pressure booster 3 also has a working chamber 14, which likewise communicates with the high-pressure source 1 via the high-pressure inlet 2.

A piston unit 17 separates the working chamber 14 and the control chamber 15 inside the pressure booster 3. The piston unit 17 can be comprised of one piece or of multiple parts and has a section with a larger diameter, whose end surface delimits the working chamber 14 of the pressure booster 3, and a piston part with a smaller diameter than this, whose lower end surface delimits a compression chamber 18 of the pressure booster 3. The compression chamber 18 of the pressure booster 3 has a compression line 20 extending from it, which at its other end, unites with the high-pressure inlet 7 that contains the check valve 8 and transitions with it into a nozzle chamber inlet 9. The control chamber 15 of the pressure booster 3 contains a spring element 16, which acts on an underside of the piston unit 17 and is supported against the bottom of the control chamber 15. The pressure booster 3 is disposed inside the injector body 5; the control chamber 15 of the pressure booster 3 has a control line 19 that is in turn connected to an annular chamber 33 of a valve element 27.

The nozzle inlet 9, which is fed by both the high-pressure line 7 and the compression line 20 extending from the compression chamber 18, feeds into a nozzle chamber 36 at a junction point 37.

A high-pressure branch 22 that contains an inlet throttle element 23 branches off from the nozzle chamber inlet 9. The high-pressure branch 22 feeds into a control chamber 21 inside a nozzle body 6 of the fuel injector 4. The control chamber 21 can be pressure-relieved by means of a control valve 25 embodied as a 2/2-way valve. An outlet throttle element 24 is provided between the control valve 25 (2/2-way valve) and the control chamber 21. A low-pressure return 26 extends from the low-pressure side of the control valve 25 (2/2-way valve) and feeds into a fuel tank, not shown here, of a motor vehicle. The control valve 25 can be either a solenoid valve or as a valve that is actuated by a piezoelectric actuator. In addition, the control valve 25 can also be embodied as a servo valve or as a valve that can be actuated directly.

The fuel injector 4 shown in FIG. 1 has an injection valve element 34, which is advantageously embodied as a nozzle needle. In the embodiment version according to FIG. 1, the injection valve element 34 is acted on by a one-piece valve element 27, which can be embodied as a valve piston. The end surface 29 of the one-piece valve element 27 delimits the control chamber 21, which can be filled via the inlet throttle restriction 23 and can be pressure-relieved via the outlet throttle restriction 24. Under the control chamber 21, the one-piece valve element 27 embodied as a valve piston is encompassed by an annular chamber 33 into which the control line 19 feeds, which connects the annular chamber 33 to the control chamber 15 of the pressure booster 3. The annular chamber 33 is provided with a control edge 31 that cooperates with a control edge 30 provided on the one-piece valve element 27. In the depiction according to FIG. 1, the control edges 30 and 31 overlap each other by a stroke distance h₁, see reference numeral 32. Below the one-piece valve element 27, the nozzle body 6 contains another hydraulic chamber that has a second low-pressure return 26.2 branching from it, which also leads to the fuel tank of the motor vehicle, not shown in FIG. 1.

The nozzle chamber inlet 9 acts on the nozzle chamber 36 of the fuel injector 4 inside the nozzle body 6 with highly pressurized fuel so that a hydraulic force is generated, which acts in the opening direction on a pressure shoulder 35 provided on the circumference surface of the injection valve element 34. Starting from the nozzle chamber 36 inside the nozzle body 6, an annular gap 38 extends to a seat 40 of the injection valve element 34 at the end oriented toward the combustion chamber. Under the seat 40 at the end oriented toward the combustion chamber, injection openings 39 are provided, which can be embodied, for example, as annular rows of openings, in the form of one or more circular arrangements of openings extending concentrically to one another. In the position of the injection valve element 34 shown in FIG. 1, the injection openings 39 are closed by the injection valve element 34, which has traveled into the seat 40 at the end oriented toward the combustion chamber so that no fuel can flow into a combustion chamber 41 of the autoignition internal combustion engine. In the depiction according to FIG. 1, the reference numeral 42 indicates the position of the injection valve element 34 in which it closes the injection openings 39. No injection of fuel into the combustion chamber 41 of the autoignition internal combustion engine occurs in this position of the injection valve element 34.

The fuel injection system has a number of fuel injectors 4 that corresponds to the number of cylinders of the autoignition internal combustion engine; each of the fuel injectors 4 has a pressure booster 3 and each fuel injector 4 is associated with a control valve 25. In the working state shown in FIG. 1, i.e. when the injection openings are closed 42, the control valve 25, which is preferably embodied as a 2/2-way control valve, is in its closed position, i.e. the control chamber 21 of the injection valve element 34 is disconnected from the low-pressure return 26. The overlapping of the control edge 31 on the nozzle body 6 and the control edge 30 on the one-piece valve element 27 closes the sliding seal constituted by the control edges 30 and 31. The injection valve element 34 is disposed in its position 42 that closes the injection openings 39 at the end oriented toward the combustion chamber and the piston unit 17 of the pressure booster 3 is pressure-balanced so that no pressure boosting is taking place. In this state shown in FIG. 1, the filling valve 10 in the first parallel line 11 that branches off from the high-pressure inlet 2 is open and the piston unit 17 of the pressure booster 3 is disposed in its starting position. The pressure prevailing inside in the high-pressure accumulator (common rail), to name an example of a high-pressure source 1, is connected via the open filling valve 10 to the back chamber 15 of the pressure booster 3 and travels via the check valve 8 contained in the high-pressure line 7 to the control chamber 21 of the fuel injector 4 as well as to its nozzle chamber 36. In this operating state, an injection can occur at any time at the pressure level prevailing in the high-pressure source 1, i.e. the rail pressure level.

However, if the control valve 25, which can preferably be embodied as a 2/2-way valve, is switched into its open position, then the control chamber 21 is pressure-relieved via the outlet throttle 24 into the first low-pressure return 26.1 on the low-pressure side of the fuel injector 4. Because of the dropping pressure in the control chamber 21 of the fuel injector 4, the hydraulic forces acting on the pressure shoulder 35 of the injection valve element 34 predominate and the injection valve element 34 opens. An injection of fuel into the combustion chamber 41 of the autoignition internal combustion engine through the injection openings 39 at the end oriented toward the combustion chamber begins at the pressure level supplied by the high-pressure source 1. Because of the series connection of the one-piece valve element 27 with the injection valve element 34, when an opening movement of the injection valve element 34 occurs, the end surface 29 of the one-piece valve element 27 travels into the control chamber 21 of the fuel injector 4. If this stroke motion exceeds the stroke distance h₁ (reference numeral 32), then the control edges 30 and 31 are no longer in the state shown in FIG. 1, i.e. the overlapping state, but are instead open so that the sliding seal is open. As a result, the control chamber 15 of the pressure booster 3 is connected to the second low-pressure return 26.2 via the control line 19 that connects the control chamber 15 to the annular chamber 33. Since the control chamber 15 of the pressure booster 3 is now pressure-relieved into the low-pressure region and the filling valve 10 closes, the piston unit 17 of the pressure booster 3 is no longer pressure-balanced; as a result, the pressure inside the working chamber 14 of the pressure booster 3 predominates and the bottom end surface of the piston unit 17 travels into the compression chamber 18. The piston unit 17 of the pressure booster 3 travels into the compression chamber 18 in accordance with the pressure area ratios of this piston unit 17, thus supplying the nozzle chamber 36 with a boosted pressure—i.e. a higher pressure than can be supplied to it by the high-pressure source 1 alone—via the combustion chamber line 20, which feeds into the nozzle inlet 9 along with the high-pressure line 7 from the high-pressure source 1. When the lower end surface of the piston unit 17 travels into the compression chamber 18, it compresses the fuel in the chamber so that a higher, i.e. boosted, pressure prevails in the nozzle chamber 36 via the nozzle inlet 9.

When the stroke distance h₁ (reference numeral 32) is exceeded, then the injection occurs at a boosted, i.e. higher, pressure. This makes it possible to achieve a boot-shaped injection. The first injection phase, e.g. the preinjection phase, takes place at the pressure level supplied by the high-pressure source 1, e.g. embodied in the form of a high-pressure accumulator (common rail), and is followed by another injection phase at a significantly higher injection pressure level, which is generated a result of the pressure area ratios in the piston unit 17 of the pressure booster 3 and is communicated via the compression chamber line 20 to the nozzle chamber 36 contained in the nozzle body 6 of the fuel injector 4.

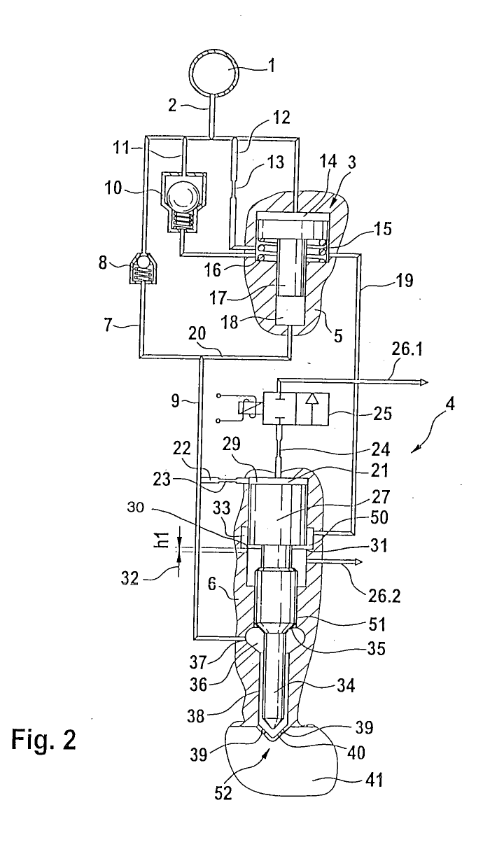

FIG. 2 shows the embodiment version of a fuel injector according to FIG. 1, with a pressure booster in a second state.

FIG. 2 shows that the housing control edge 31 in the nozzle body 6 and the control edge 30 of the one-piece valve element 27 are not overlapping, which produces a low-pressure connection 50 between the control chamber 15 of the pressure booster 3 via the control line 19, which into the annular chamber 33 that encompasses the one-piece valve element 27. The control chamber 15 is thus pressure-relieved via the second low-pressure return 26.2 so that the piston unit 17, due to the pressure prevailing in the working chamber 14 of the pressure booster 3, compresses the fuel volume contained in the compression chamber 18 of the pressure booster 3 and conveys it via the compression chamber line 20 and the nozzle inlet 9 into the nozzle chamber 36 of the nozzle body 6. The injection valve element 34 of the fuel injector 4 is then disposed in its retracted position 51, i.e. its open position, so that fuel is injected via the nozzle chamber 36, the annular gap 38, and the opened injection openings 39 into the combustion chamber 41 of the autoignition internal combustion engine at a very high pressure, which corresponds to the pressure-boosted, increased pressure level.

In order to terminate the injection, the control valve 25, which is preferably embodied as a 2/2-way valve, is closed so that a pressure increase occurs in the control chamber 21 of the injection valve element 34. Due to the action on the end surface 29 of the one-piece valve element 27, the injection valve element 34 that cooperates with it moves in the closing direction. When the control edge 31 on the nozzle body 6 is reached, the control edges 30 and 31 overlap each other so that the sliding seal they produce is closed. This closes the connection of the control chamber 15 via the control line 19 and the annular chamber 33 into the low-pressure return 26, thus deactivating the pressure booster 3. The injection valve element 34 moves further in the direction of its seat 40 at the end oriented toward the combustion chamber and thus at a later point, closes the injection openings 39 that feed into the combustion chamber 41 of the autoignition internal combustion engine. Since the pressure booster 3 is already deactivated, pressure surges that occur with the closing of the injection valve element 34 are compensated for.

The shut-off time of the pressure booster 3, i.e. the moment at which the control edges 30 and 31 overlap each other, can be optimally matched to the end of the respective injection phase by adjusting the stroke distance h₁ (reference numeral 32) and the closing speeds of the injection valve element 34 and the valve element 27. With small injection quantities, such as in a preinjection, the injection valve element 34, which is preferably embodied as a nozzle needle, cannot be completely opened along the entire stroke distance h₁ (reference numeral 32), as a result of which the pressure booster 3 remains deactivated. Consequently, any number of preinjections can be executed without an activated pressure booster 3. In preinjections for conditioning the combustion mixture contained in the combustion chamber 41, the preinjections are executed at the pressure level supplied by the high-pressure source 1, for example a high-pressure accumulator (common rail), and not at the increased pressure level that can be achieved by means of the pressure booster 3. The number and duration of the respective preinjection phases, as well as the duration of the main injection at an increased pressure level, can be set by adjusting the triggering time of the control valve 25.

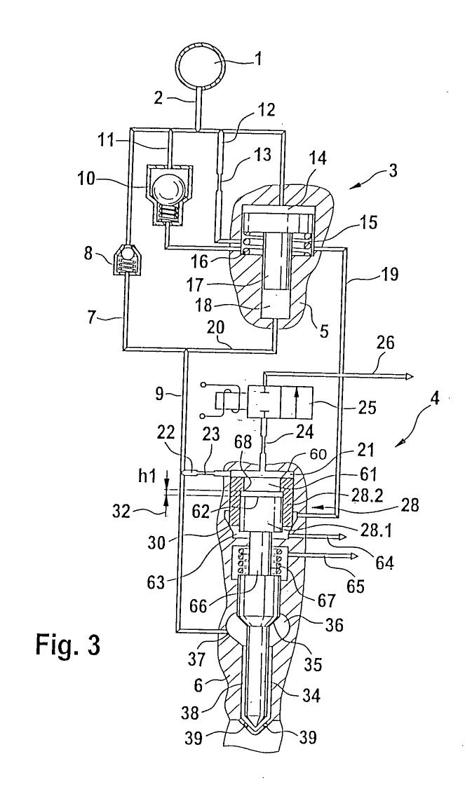

FIG. 3 shows another embodiment version of a pressure booster that is actuated by an injection valve element, with two valve elements guided one inside the other.

The fuel injector 4 shown in FIG. 3, which is for supplying fuel to an autoignition internal combustion engine, also has a pressure booster 3 integrated into the injector body 5. Via a high-pressure inlet 2, the high-pressure source 1 acts on a high-pressure line 7, a first parallel branch 11, an additional parallel branch 12, and the working chamber 14 of the pressure booster 3. The first parallel branch 11 contains a filling valve 10 and the additional parallel branch 12 contains a throttle restriction 13. The high-pressure line 7 contains a check valve 8.

Analogous to the pressure booster 3 shown in FIG. 1, the pressure booster 3 in the additional embodiment version in FIG. 3 has a piston unit 17 that divides the working chamber 14 from the control chamber 15. The underside of the piston unit 17 acts on the compression chamber 18 in the injector body 5 of the pressure booster 3 and, branching off from this compression chamber 18, the compression chamber line 20 leads to the nozzle chamber inlet 9 and unites with the high-pressure line 7 from the high-pressure source 1.

By contrast with the embodiment version of the design proposed according to the invention shown in FIGS. 1 and 2, the injection valve element 34 according to the depiction in FIG. 3 is acted on by a multi-part valve element 28. The multi-part valve element 28 has a first valve element 28.1 with an additional, second valve element 28.2 encompassing it. The first valve element 28.1 and the additional valve element 28.2 can be embodied as piston-shaped. An annular surface 60 on the second valve element 28.2 partially delimits the control chamber 21. The second valve element 28.2 contains an opening 61 via which an end surface 62 of the first valve element 28.1 can be acted on by the pressure prevailing in the control chamber 21. According to this embodiment version, a stroke distance h₁ (reference numeral 32) is established between the inner, first valve element 28.1, i.e. its end surface 62, and a collar at the opening 61 in the second valve element 28.2 of the multi-part valve element 28. The second valve element 28.2 has a control edge 30 that cooperates with a seat of a valve chamber 63. The control line 19 from the control chamber 15 of the pressure booster 3 feeds into the valve chamber 63 above the seat. A first return line 64 branches off from the valve chamber 63 and leads to the low-pressure side of the fuel supply system. The first valve element 28.1 has a piston extension 66 that has a smaller diameter than the piston part of the first valve element 28.1. The piston extension 66 passes through an additional cavity, which is disposed underneath the valve chamber 63 in the nozzle body 6 and contains a closing spring 67. The end surface of the piston extension 66 rests against the end surface of the injection valve element 34, which is preferably embodied as a nozzle needle.

When the pressure in the control chamber 21 is relieved by the control valve 25, which is preferably embodied as a 2/2-way valve, and the nozzle chamber 36 of the injection valve element 34 is acted on at the same time, a hydraulic force builds up in the nozzle chamber 36 via the nozzle chamber inlet 9, which force acts on the pressure shoulder 35 of the injection valve element 34. The injection valve element 34 opens, thus allowing the execution, for example, of a preinjection via the injection opening 39 into a combustion chamber, not shown here, of an internal combustion engine. The preinjection, however, occurs only at the pressure level prevailing in the high-pressure source 1 since the pressure booster 3 is not activated at this point. With further pressure-relief of the control chamber 21, the end surface 62 of the inner, first valve element 28.1 comes into contact with the collar-shaped stop of the second, outer valve element 28.2 and carries the outer, second valve element 28.2 along with it in the opening direction. As a result, the control edge 30 on the outer circumference of the second valve element 28.2 opens the connection of the control chamber 15 to the first return line 64 via the control line 19 and the valve chamber 63 so that the pressure in the control chamber 15 of the pressure booster 3 is relieved. The piston unit 17 of the pressure booster 3 thus travels into the compression chamber 18 so that fuel is conveyed at an increased pressure via the compression chamber line 20, the nozzle chamber inlet 9, and the junction point 37 into the nozzle chamber 36 in the nozzle body 6. It is now possible to execute a subsequent injection into the combustion chamber of the autoignition internal combustion engine at an increased pressure level that corresponds to the pressure boosting of the pressure booster 3. In addition to the first return line 64 that branches off from the valve chamber 63, the additional embodiment version of a fuel injector according to the invention shown in FIG. 3 has a second return line 65 into the low-pressure region of the fuel supply system, which branches off from the cavity containing the closing spring element 67 above the injection valve element 34. In the depiction according to FIG. 3, the reference numeral 68 indicates the stop point at which, with further pressure-relief of the control chamber 21, the end surface 62 of the inner, first valve element 28.1 comes to rest against the outer, second valve element 28.2 and carries it along with it in the opening direction.

The remaining components of the fuel injector 4 according to the embodiment version shown in FIG. 3 that are not discussed in detail above essentially correspond to the components that have already been described in the embodiment version of the fuel injector according to the invention in FIGS. 1 and 2.

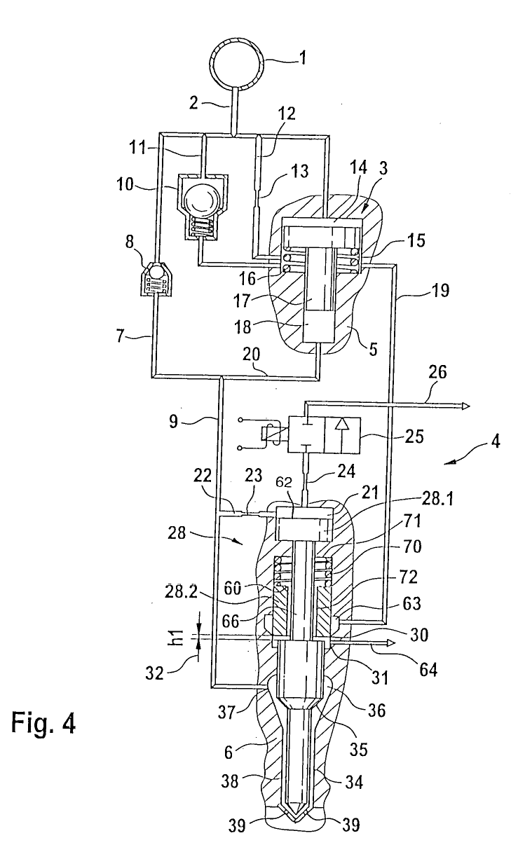

FIG. 4 shows an embodiment version of a pressure booster that is actuated by an injection valve element, with two valve elements, one of which is embodied as spring-loaded.

From the high-pressure source 1, the high-pressure inlet 2 extends via a high-pressure line branch 7 that contains a check valve 8 and via a first parallel branch 1 1 and an additional parallel branch 12 to the control chamber 15 of the pressure booster 3. In addition, the high-pressure source 1, which is embodied for example as a high-pressure accumulator (common rail), acts on the working chamber 14 of the pressure booster 3 directly. The working chamber 14 and the control chamber 15 of the pressure booster 3 are separated from each other by a piston unit 17, the end surface of the piston unit 17 oriented toward the working chamber 14 having a larger diameter than the end surface of the piston unit 17 that delimits the compression chamber 18 of the pressure booster 3. The compression chamber 18 inside the injector body 5 of the fuel injector 4 has a compression chamber line 20 branching off from it, which unites with the high-pressure line 7 containing the check valve 8 and transitions into the nozzle chamber inlet 9.

The control chamber 21 inside the fuel injector 4 is acted on with pressure via a high-pressure branch 22 with an inlet throttle restriction 23 and can be pressure-relieved into the low-pressure return 26 via an outlet throttle restriction 24 through actuation of a control valve 25.

A multi-part valve element 28 is also used in the embodiment version of the fuel injector 4 shown in FIG. 4. The multi-part valve element 28 that acts on the injection valve element 34 in the nozzle body 6 of the fuel injector 4 includes a first valve element 28.1 whose end surface 62 delimits the control chamber 21. The first valve element 28.1 has a piston extension 66 whose bottom end surface rests against the end surface of the injection valve element 34. The first valve element 28.1 is encompassed by a second, additional valve element 28.2; a continuous gap 72 is provided between the first valve element 28.1 and the second valve element 28.2. By contrast with the embodiment version shown in FIG. 3, the second valve element 28.2 does not delimit the control chamber 21, but is instead disposed underneath the first valve element 28.1 and its annular surface 60 is acted on by a spring element 70. The spring element 70 rests against the top 71 of the valve chamber 63 in the nozzle body 6 of the fuel injector 4.

The spring element 70 contained in the valve chamber 63 presses the control edge 30 of the second, sleeve-shaped valve element 28.2 into its closed position so that the valve seat between the control edge 30 and the housing edge 31 of the valve chamber 63 is closed in the idle position and the pressure booster 3 is deactivated. Since the control edges 30 on the second valve element 28.2 and the control edge 31 on the valve chamber 63 close the seat, it is not possible for the pressure in the control chamber 15 to be relieved into the valve chamber 63 via the line 19 so that the piston unit 17 between the working chamber 14 and the control chamber 15 of the pressure booster 3 is disposed in its starting position. A corresponding pressure shoulder inside the valve chamber 63 can serve to generate a closing hydraulic compression force in order to increase the closing force on the control edge 30.

After the triggering of the control valve 25, which is preferably embodied as a 2/2-way control valve, a pressure-relief occurs in the control chamber 21 so that the end surface 62 of the first valve element 28.1 travels into this chamber. If the control chamber 21 above the end surface 62 of the first valve element 28.1 is pressure-relieved until the end surface of the injection valve element 34 comes to rest against the lower annular surface of the second valve element 28.2, i.e. if the stroke distance h₁ (reference numeral 32) is exceeded, then the injection valve element 34 activates the pressure booster 3 since the hydraulic force acting on the pressure shoulder 35 in the nozzle chamber 36 opens the sealed seat between the control edges 30 on the second valve element 28.2 and the control edge 31 of the valve chamber 63, and a pressure decrease in the control chamber 15 of the pressure booster 3 can occur via the line 19 leading into the first low-pressure return 64. As a result, the fuel compressed in the compression chamber 18 of the pressure booster 3 is supplied to the nozzle chamber 36 via the compression chamber line 20, the nozzle chamber inlet 9, and the junction point 37 at which the nozzle chamber inlet 9 adjoins the nozzle chamber 36. With an appropriate pressure-relief of the control chamber 21 of the injection valve element 34 within certain limits, i.e. so that the retraction path of the injection valve element 34 is less than the stroke distance h₁ (reference numeral 32), the design shown in FIG. 4 can produce preinjections at the pressure level prevailing in the high-pressure source 1; a longer-lasting pressure-relief of the control chamber 21 above the injection valve element 34 activates the pressure booster 3 and a main injection phase with rate-shaping can be executed at an increased pressure level. In accordance with the triggering cycle of the control valve 25, one or more preinjection phases can be executed, depending solely on the triggering times and the triggering program of the control valve 25, which preferably can be embodied as a 2/2-way valve. In the embodiment versions proposed according to the invention and shown respectively in FIGS. 1 and 2 and in FIGS. 3 and 4, with less than a certain needle stroke h₁ (reference numeral 32), an injection of fuel into the combustion chamber 41 of an autoignition internal combustion engine can be executed at a first pressure level that corresponds, for example, to the pressure level of a high-pressure source 1. Once the needle stroke h₁ (reference numeral 32) is exceeded, the injection valve element 34 activates the pressure booster 3 so that a subsequent injection then occurs at an increased pressure level. On the one hand, this permits the production of a boot-shaped injection since the first injection phase (preinjection) occurs at a lower pressure level than the subsequent main injection. The activation of the pressure booster 3 through the vertical stroke motion of the injection valve element 34 causes an increased pressure level to occur at precisely the moment required in terms of process engineering, in accordance with the combustion progression occurring in the combustion chamber 41 of the autoignition internal combustion engine. In the range of small injection quantities, the injection valve element 34 can carry out a preinjection by executing a pressure-relief of the control chamber 21, this pressure-relief being controlled with regard to its relief duration in such a way as not to exceed the stroke distance h₁ (reference numeral 32) so that the pressure booster 3 remains deactivated. The design proposed according to the invention can therefore execute any number of preinjections at a pressure level that is low in comparison that which is produced when the pressure booster 3 is activated, thus allowing the fuel injector 4 according to the design proposed according to the invention to be operated with only one control valve 25.

Reference Numeral List

1 high-pressure source (common rail)
2 high-pressure inlet
3 pressure booster
4 fuel injector
5 injector body
6 nozzle body
7 high-pressure line
8 check valve
9 nozzle chamber inlet branch
10 filling valve
11 first parallel branch
12 second parallel branch
13 throttle restriction
14 working chamber
15 control chamber
16 spring element
17 piston unit
18 compression chamber
19 control line for control chamber
20 compression chamber line
21 control chamber
22 high-pressure branch to control chamber
23 inlet throttle restriction
24 outlet throttle restriction
25 control valve (2/2-way valve)
26.1 first low-pressure return
26.2 second low-pressure return
27 one-piece valve element
28 multi-part valve element
28.1 first valve element
28.2 second valve element
29 end surface of one-piece valve element
30 control edge of valve element
31 control edge of housing
32 stroke distance h₁
33 annular chamber of valve element
34 injection valve element
35 pressure shoulder
36 nozzle chamber
37 junction point of nozzle chamber inlet
38 annular gap
39 injection opening
40 seat at end oriented toward the combustion chamber
41 combustion chamber
42 closed injection opening
50 low-pressure connection
51 injection valve element 34 (retracted position)
52 open injection openings
60 annular surface of second valve element
61 opening
62 end surface of first valve element
63 valve chamber
64 first return line
65 second return line
66 piston extension
67 closing spring
68 stop of first valve element on second valve element
70 spring element for second valve element
71 stop for spring element
72 overflow gap

1-17. (canceled)

18. In a device for injecting fuel into a combustion chamber (41) of an internal combustion engine, comprising an injector body (5, 6), which contains an injection valve element (34) that can be actuated by a pressurization/pressure relief of a control chamber (21) executed by a control valve (25), and a pressure booster (3) that has a piston unit (17), which divides a working chamber (14) from a control chamber (15) and acts on a compression chamber (18) that communicates (9, 20) with a nozzle chamber (36) encompassing the injection valve element (34), the improvement wherein the pressurization (2, 11, 12)/pressure relief (19, 26, 64) of the control chamber (15) of the pressure booster (3) occurs as a function of the stroke motion of the injection valve element (34).

19. The device for injecting fuel according to claim 18, further comprising a valve element (27, 28) that can move inside a hydraulic chamber (33, 63), which is fed by a control line (19) leading from the control chamber (15) of the pressure booster (3), the injection valve element (34) being associated with the valve element (27, 28).

20. The device for injecting fuel according to claim 19, wherein the valve element (27, 28) disposed inside the hydraulic chamber (33, 63) acts on the end surface of the injection valve element (34) oriented away from the injection openings (39) disposed at the end oriented toward the combustion chamber.

21. The device for injecting fuel according to claim 19, further comprising a surface (29, 60, 62) of the valve element (27, 28), which surface can be acted on hydraulically, protrudes into a control chamber (21) that exerts pressure on the injection valve element (34).

22. The device for injecting fuel according to claim 19, wherein the valve element (27) is comprised of one piece and has a control edge (30) that forms a sliding seal with a control edge (31) in the hydraulic chamber (33).

23. The device for injecting fuel according to claim 19, further comprising a return line (26.2, 64) branching from the hydraulic chamber (33, 63), which return line leads into the low-pressure region.

24. The device for injecting fuel according to claim 22, further comprising a return line (26.2, 64) branching from the hydraulic chamber (33, 63), which return line leads into the low-pressure region, and wherein with a stroke motion of the injection valve element (34), which is triggered by a pressure-relief of the control chamber (21) and is shorter than a stroke distance h₁ (32) at which the control edges (30, 31) overlap, the sliding seal (30, 31) remains closed and an injection of fuel into a combustion chamber (41) occurs at a first pressure level.

25. The device for injecting fuel according to claim 22, further comprising a return line (26.2, 64) branching from the hydraulic chamber (33, 63), which return line leads into the low-pressure region, and wherein with a stroke motion of the injection valve element (34), which is triggered by further pressure-relief of the control chamber (21) and exceeds the stroke distance h₁ (32), the control chamber (15) of the pressure booster (3) can be connected to the second low-pressure return (26.2) via the control line (19) and the open control edges (30, 31) and an injection of fuel into a combustion chamber (41) occurs at a second, higher pressure level.

26. The device for injecting fuel according to claim 19, wherein the valve element (28) is comprised of multiple parts and has a first valve part (28.1) and a second valve part (28.2), at least one of which is acted on by the pressure prevailing in the control chamber (21) of the injection valve element (34).

27. The device for injecting fuel according to claim 26, wherein the first valve part (28.1) is guided in the second valve part (28.2) and a stroke distance h₁ (32) is established between an end surface (29) of the first valve part (28.1) and a stroke stop (68) of the second valve part (28.2).

28. The device for injecting fuel according to claim 27, wherein the second valve part (28.2) has a control edge (30) that cooperates with a sealing seat in the hydraulic chamber (63).

29. The device for injecting fuel according to claim 27, wherein the second valve part (28.2) has a control edge (30) that cooperates with a sealing seat in the hydraulic chamber (63), and wherein, when the control chamber (21) is pressure-relieved, the first valve part (28.1) travels the stroke distance h₁ (32) toward the stop (68) and the injection valve element (34) executes an injection of fuel into the combustion chamber (41) at a first pressure level.

30. The device for injecting fuel according to claim 27, wherein the second valve part (28.2) has a control edge (30) that cooperates with a sealing seat in the hydraulic chamber (63), and wherein with further pressure-relief of the control chamber (21), after the first valve part (28.1) travels the stroke distance h₁ (32), opening the second valve part (28.2) at the sealing seat in the hydraulic chamber (63), the control chamber (15) is pressure-relieved into the low-pressure side via the control line (19) and the hydraulic chamber (63), and an injection of fuel occurs at a second, higher pressure level.

31. The device for injecting fuel according to claim 26, further comprising a spring element (70) acting on one of the valve parts (28.1, 28.2) of the multi-part valve element (28) in the direction of a sealing seat in the hydraulic chamber (63).

32. The device for injecting fuel according to claim 26, further comprising a spring element (70) acting on one of the valve parts (28.1, 28.2) of the multi-part valve element (28) in the direction of a sealing seat in the hydraulic chamber (63), and a piston extension (66) of the first valve part (28.1) which passes through the second valve part (28.2) and forming an annular gap (72) with it, and the piston extension (66) of the first valve part (28.1) acting on the end surface of the injection valve element (34).

33. The device for injecting fuel according to claim 26, further comprising a spring element (70) acting on one of the valve parts (28.1, 28.2) of the multi-part valve element (28) in the direction of a sealing seat in the hydraulic chamber (63), and wherein a stroke distance h₁ (32) between the second valve part (28.2) and the injection valve element (34) can be established, by which the injection valve element (34) can be moved with pressure-relief of a control chamber (21) in order to inject fuel at a first pressure level.

34. The device for injecting fuel according to claim 26, wherein a spring element (70) acting on one of the valve parts (28.1, 28.2) of the multi-part valve element (28) in the direction of a sealing seat in the hydraulic chamber (63), a stroke distance h₁ (32) between the second valve part (28.2) and the injection valve element (34) can be established, by which the injection valve element (34) can be moved with pressure-relief of a control chamber (21) in order to inject fuel at a first pressure level and wherein a stroke distance h₁ (32) between the second valve part (28.2) and the injection valve element (34) can be established, by which the injection valve element (34) can be moved with pressure-relief of a control chamber (21) in order to inject fuel at a first pressure level, and wherein with further pressure-relief of the control chamber (21) and an opening movement of the injection valve element (34) that exceeds the stroke distance h₁ (32), the injection valve element (34) moves the second valve part (28.2) away from its seat in the hydraulic chamber (63) and pressure-relieves the control chamber (15) of the pressure booster (3) into the low-pressure side via a control line (19) so that an injection of fuel into the combustion chamber (41) occurs at a second, higher pressure level.
